(19) United States
(12) Patent Application Publication
(10) Pub. No.: US 2008/0225069 A1
(43) Pub. Date: Sep. 18, 2008

(54) LIQUID EJECTION HEAD, METHOD FOR CONTROLLING THE SAME, AND PRINTER

(75) Inventor: Hiromu MIYAZAWA, Azumino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/048,288

(22) Filed: Mar. 14, 2008

(30) Foreign Application Priority Data
Mar. 15, 2007 (JP) 2007-066614

(51) Int. Cl. B41J 2/045; B41J 29/38; B41J 29/393

(52) U.S. Cl. 347/14; 347/19; 347/70

(57) ABSTRACT

A method for controlling a liquid jet head includes: a first step of applying a specified voltage to the liquid jet head to eject a droplet; a second step of measuring the speed of the droplet by using a laser beam; a third step of comparing the speed of the droplet measured and a reference value; and a fourth step of re-setting the voltage according to a comparison result.

The entire disclosure of Japanese Patent Application No. 2007-066614, filed Mar. 15, 2007 is expressly incorporated by reference herein.

### BACKGROUND

1. Technical Field

The present invention relates to liquid jet heads, methods for controlling the same, and printers.

2. Related Art

The ink jet method has been put into practical use as a high resolution and high speed printing method. For ejecting ink droplets, it is useful to employ piezoelectric elements with the structure in which a piezoelectric layer is sandwiched by electrodes (see, for example, Japanese Laid-open patent application JP-A-2001-223404).

### SUMMARY

In accordance with an advantage of some aspects of the invention, a method for controlling a liquid jet head which can improve the reliability can be provided. Moreover, liquid jet heads and printers that can achieve the aforementioned method for controlling a liquid jet head can be provided.

A method for controlling a liquid jet head in accordance with an embodiment of the invention includes: a first step of applying a specified voltage to the liquid jet head to eject a droplet; a second step of measuring the speed of the droplet by using a laser beam; a third step of comparing the speed of the droplet measured and a reference value; and a fourth step of resetting the voltage according to a comparison result.

According to the method for controlling a liquid jet head in accordance with the embodiment of the invention, droplets each having a desired droplet weight can be ejected. As a result, for example, when the liquid jet head is used for an extended period of time, changes in the droplet weight can be suppressed, and the reliability of the liquid jet head can be improved.

In the method for controlling a liquid jet head in accordance with an aspect of the embodiment of the invention, a series of the first step through the fourth step may be repeated a plurality of times.

In the method for controlling a liquid jet head in accordance with an aspect of the embodiment of the invention, in the second step, the droplet may pass through the laser beam in two points, and the speed of the droplet may be obtained from a distance between the two points and a time for which the droplet travels the distance.

A liquid jet head in accordance with an embodiment of the invention includes: a nozzle plate having a nozzle aperture connecting to a pressure chamber; a substrate formed above the nozzle plate and having an opening section composing the pressure chamber; an elastic plate formed above the pressure chamber; a driving section formed above the elastic plate; and a measurement section that is formed below the nozzle plate and measures the speed of a droplet ejected from the nozzle aperture with a laser beam.

It is noted that, in the descriptions concerning the invention, the term “above” may be used, for example, as “a specific element (hereafter referred to as “A”) is formed ‘above’ another specific element (hereafter referred to as “B”).” In the descriptions concerning the invention, in this case, the term “above” is assumed to include a case in which A is formed directly on B, and a case in which A is formed above B through another element.

Also, in the descriptions concerning the invention, the term “below” may be used, for example, as “a specific element (hereafter referred to as “C”) is formed ‘below’ another specific element (hereafter referred to as “D”).” In the descriptions concerning the invention, in this case, the term “below” is assumed to include a case in which C is formed directly on an underside of D, and a case in which C is formed below D through another element.

In the liquid jet head in accordance with an aspect of the embodiment of the invention, the measurement section may include a laser element that emits the laser beam, a reflection section that reflects the laser emitted from the laser element and directs the laser beam in an opposite direction, and a light detecting element that detects the laser beam, wherein an optical axis of the laser element and an optical axis of the light detecting element are in parallel with each other, and traverse a region vertically below the nozzle aperture; the laser element and the reflection section are disposed at a position where the laser beam emitted from the laser element is incident upon the reflection section with the optical axis of the laser element being an optical path; and the reflection section and the light detecting element are disposed at a position where the laser beam reflected from the reflection section is incident upon the light detecting element with the optical axis of the light detecting element being as an optical path.

In the liquid jet head in accordance with an aspect of the embodiment of the invention, the measurement section may include two laser elements that emits laser beams, and two light detecting elements that receive the laser beams, wherein optical axes of the two laser elements may be in parallel with each other and traverse a region vertically below the nozzle aperture; the optical axis of one of the laser elements may align with an optical axis of one of the light detecting elements; and the optical axis of the other of the laser elements may align with an optical axis of the other of the light detecting elements.

In the liquid jet head in accordance with an aspect of the embodiment of the invention, the driving section may include a lower electrode, a piezoelectric layer formed above the lower electrode, and an upper electrode formed above the piezoelectric layer.

A printer in accordance with an embodiment of the invention includes the liquid jet head described above.

A printer in accordance with an embodiment of the invention includes a head unit having the liquid jet head described above, a head unit driving section that reciprocates the head unit, and a control section that controls the head unit and the head unit driving section.

A printer in accordance with an embodiment of the invention includes a head unit having a liquid jet head, a measurement section that measures the speed of a droplet ejected from the liquid jet head with a laser beam, a head unit driving section that reciprocates the head unit, and a control section that controls the head unit, the measurement section and the head unit driving section.

### BRIEF DESCRIPTION OF THE DRAWINGS

FIG. 1 is a schematic cross-sectional view of a liquid jet head in accordance with an embodiment of the invention.

FIG. 2 is a schematic exploded perspective view of a liquid jet head in accordance with an embodiment of the invention.

FIG. 3 is a flow chart of a method for controlling a liquid jet head in accordance with an embodiment of the invention.

FIG. 4 is a schematic cross-sectional view showing a step of a method for controlling a liquid jet head in accordance with an embodiment of the invention.

FIG. 5 is a schematic cross-sectional view showing a step of the method for controlling a liquid jet head in accordance with the embodiment of the invention.

FIG. 6 is a graph showing the relation between the elapsed time and the amount of light of a laser beam that is incident upon a light detecting element.

FIG. 7 is a graph showing the relation between the driving voltage and the speed of a droplet and the relation between the driving voltage and the weight of a droplet.

FIG. 8 is a schematic cross-sectional view showing a step of a method for manufacturing a liquid jet head in accordance with an embodiment of the invention.

FIG. 9 is a schematic cross-sectional view of a liquid jet head in accordance with a modified example of the embodiment of the invention.

FIG. 10 is a schematic perspective view of a printer in accordance with an embodiment of the invention.

### DESCRIPTION OF EXEMPLARY EMBODIMENTS

Preferred embodiments of the invention are described below with reference to the accompanying drawings.

### 1. First Embodiment

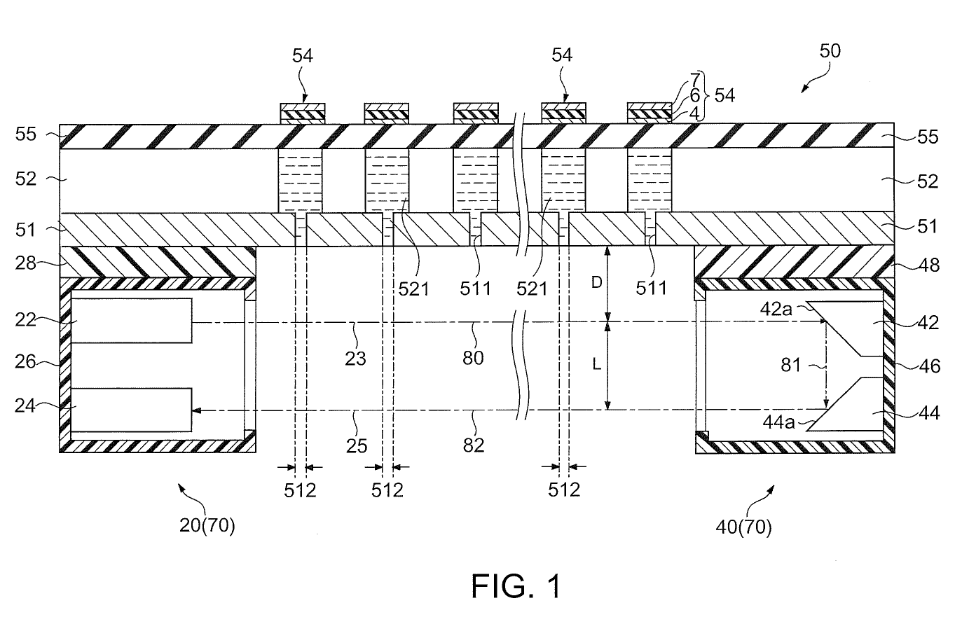

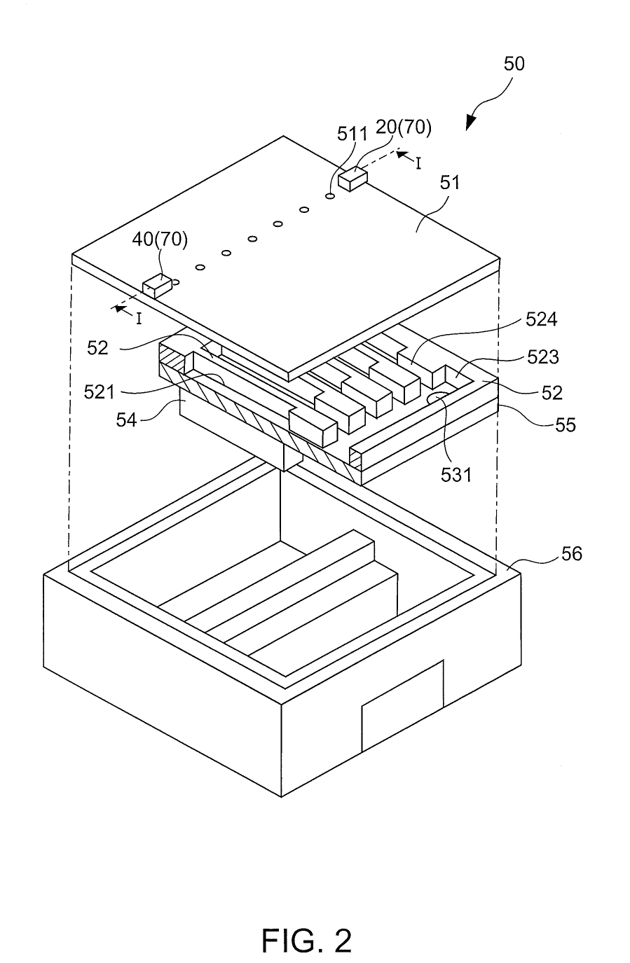

1.1. First, a liquid jet head 50 in accordance with a first embodiment of the invention is described. Here, the case where the liquid jet head 50 is an ink jet recording head is described. FIG. 1 is a schematic cross-sectional view of the liquid jet head 50 in accordance with the embodiment. FIG. 2 is a schematic exploded perspective view of the liquid jet head 50 in accordance with the embodiment, illustrated upside down with respect to the state in which the liquid jet head 50 is normally used. It is noted that FIG. 1 is a cross-sectional view taken along lines I-I of FIG. 2. Also, FIG. 2 schematically shows laser beams 80, 81 and 82 by arrows for the sake of convenience. Moreover, in FIG. 2, illustrations of a driving section 54 and a measurement section 70 are simplified for the sake of convenience.

The liquid jet head 50 may include, as shown in FIG. 1 and FIG. 2, a nozzle plate 51, a substrate 52, an elastic plate 55, a driving section 54, and a measurement section 70. The liquid jet head 50 may further include a housing 56.

The nozzle plate 51 has nozzle apertures 511 that connect to a pressure chamber 521. Droplets (ink droplets) are ejected through the nozzle apertures 511. The nozzle plate 51 may be provided with, for example, a row of multiple nozzle apertures 511. The nozzle plate 51 may be made from, for example, a rolled plate of stainless steel (SUS).

In the state of normal use, the substrate 52 is formed on the nozzle plate 51 (though it is shown below in FIG. 2). As the substrate 52, for example, a (110) single crystal silicon substrate (with a plane orientation <110>) may be used. The substrate 52 partitions the space between the nozzle plate 51 and the elastic plate 55, thereby providing a liquid reservoir section (reservoir) 523, supply ports 524 and a plurality of pressure chambers (cavities) 521. For example, the pressure chamber 521 is composed of an opening section 521 provided in the substrate 52. Each of the pressure chambers 521 is disposed for each of the nozzle apertures 511. The pressure chamber 521 has a volume that is variable by deformation of the elastic plate 55. The volume change causes an ink to be ejected from the pressure chamber 521.

The elastic plate 55 is formed at least on the pressure chambers 521. Furthermore, the elastic plate 55 may be formed, for example, on the liquid reservoir section 523, the supply ports 524 and the substrate 52. As the elastic plate 55, for example, a layer in which a zirconium oxide (ZrO₂) layer is laminated on a silicon oxide (SiO₂) layer may be used. The elastic plate 55 is provided with a through-hole 531 that penetrates the elastic plate 55 in its thickness direction. The liquid reservoir section 523 temporarily stores ink that is supplied from the outside (for example, from an ink cartridge) through the through-hole 531. Ink is supplied to each of the pressure chambers 521 from the liquid reservoir section 523 through each of the corresponding supply ports 524. It is noted that, for example, water soluble pigments ink for photo printing may be used as the ink.

The driving sections 54 are formed on the elastic plate 55. The driving sections 54 are electrically connected to a piezoelectric element driving circuit (not shown), and can operate (vibrate, deform) based on signals provided by the piezoelectric element driving circuit. The elastic layer 55 deforms by deformation of the driving section 54, and can instantaneously increase the inner pressure of the pressure chamber 521. As the system for the driving section 54, for example, a piezoelectric system or a thermal system may be used. As the structure of the driving section 54, for example, a laminated piezoelectric structure, a thin film piezoelectric structure or the like may be used.

Each of the driving sections 54 may include, for example, a lower electrode 4 formed on the elastic plate 55, a piezoelectric layer 6 formed on the lower electrode 4, and an upper electrode 7 formed on the piezoelectric layer 6. As the lower electrode 4, for example, a layer in which an iridium (Ir) layer is laminated on a platinum (Pt) layer may be used. The piezoelectric layer 6 may be composed of, for example, lead zirconate titanate (Pb(Zr, Ti)O₃: PZT), lead zirconate titanate solid solution, or the like. As the lead zirconate titanate solid solution, for example, lead zirconate titanate niobate (Pb(Zr, Ti, Nb)O₃: PZTN) may be used. As the upper electrode 7, for example, an iridium (Ir) layer may be used. The lower electrode 4, the piezoelectric layer 6 and the upper electrode 7 may form, for example, a columnar laminate (columnar section).

The measurement section 70 is formed below the nozzle plate 51. The measurement section 70 may include, for example, an optical element section 20 and a reflection section 40. The optical element section 20 may include, for example, a laser element 22, a light detecting element 24, an optical element housing 26, and a first spacer 28. The reflection section 40 may include, for example, a first mirror 42, a second mirror 44, a mirror housing 46 and a second spacer 48. The measurement section 70 may be connected to wirings (not shown).

The laser element 22 is capable of emitting a laser beam 80. As the laser element 22, for example, a gallium arsenide (GaAs) type surface-emitting laser diode may be used. The wavelength of the laser beam 80 may be, for example, 850 nm. The laser beam 80 emitted from the laser element 22 can advance along an optical axis 23 of the laser element 22 as an optical path. The spot diameter of the laser beam 80 emitted is, for example, 10 μm in the region where the droplet speed is measured (to be described below).

The light detecting element 24 can detect the laser beam 82. The light detecting element 24 can be provided, for example, below the laser element 22. As the light detecting element 24, for example, a photodiode (such as, a pin photodiode) may be used.

The optical axis 23 of the laser element 22 and the optical axis 25 of the light detecting element 24 are in parallel with each other, for example, along the horizontal direction. Also, the optical axis 23 of the laser element 22 and the optical axis 25 of the light detecting element 24 traverse, for example, a region 512 vertically below each of the nozzle apertures 511.

The reflection section 40 is capable of reflecting the laser beam 80 emitted from the laser element 22, and outputting the laser beam (reflected beam) 82 in an opposite direction with respect to the direction in which the laser beam 80 emitted from the laser element 22. More specifically, first, the laser beam 80 emitted from the laser element 22 is reflected by, for example, a first mirror 42. The first mirror 42 has a reflection surface 42a that is angled, for example, at 45 degrees with respect to the laser beam 80. A laser beam (first reflected beam) 81 after being reflected by the first mirror 42 may advance, for example, in a vertically downward direction. Then, the first reflected beam 81 is reflected by, for example, a second mirror 44. The second mirror 44 has a reflection surface 44a that is angled, for example, at 45 degrees with respect to the first reflected beam 81. A laser beam (second reflected beam) 82 after being reflected by the second mirror 44 may be outputted from the reflection section 40, and advance, for example, along the optical axis 25 of the light detecting element 24 as an optical path. It is noted that the number of reflections at the reflection section 40 is not limited to two times.

The laser element 22 and the reflection section 40 may be disposed at positions where the laser beam 80 emitted from the laser element 22 is incident upon the reflection section 40 along the optical axis 23 of the laser element 22 as an optical path. The reflection section 40 and the light detecting element 24 may be disposed at positions where the laser beam 82 outputted from the reflection section 40 is incident upon the light detecting element 24 along the optical axis 25 of the light detecting element 24 as an optical path.

The distance between the nozzle plate 51 and the optical axis 23 of the laser element 22 (in other words, the distance between the nozzle plate 51 and the laser beam 80) D is, for example, 100 μm or greater but 1 cm or less.

The optical element housing 26 can store the laser element 22 and the light detecting element 24. The laser element 22 and the light detecting element 24 are affixed on the inside of the optical element housing 26. A mirror housing 46 can store the first mirror 42 and the second mirror 44. The first mirror 42 and the second mirror 44 are affixed on the inside of the mirror housing 46. The optical element housing 26 and the mirror housing 46 may be formed with, for example, any of a variety of resin materials and any of a variety of metal materials.

The first spacer 28 may be provided below the nozzle plate 51 and on the optical element housing 26. By adjusting the thickness of the first spacer 28, the position of the optical element housing 26 in the vertical direction, and therefore the positions of the laser element 22 and the light detecting element 24 in the vertical direction can be adjusted. It is noted that the first spacer 28 may not necessarily be provided. The second spacer 48 may be provided below the nozzle plate 51 and on the mirror housing 46. By adjusting the thickness of the second spacer 48, the position of the mirror housing 46 in the vertical direction, and therefore the positions of the first mirror 42 and the second mirror 44 in the vertical direction can be adjusted. It is noted that the second spacer 48 may not necessarily be provided. The first spacer 28 and the second spacer 48 may be formed with, for example, any of a variety of resin materials and any of a variety of metal materials.

The housing 56 can stored the members described above. The housing 56 may be formed with, for example, any of a variety of resin materials and any of a variety of metal materials.

It is noted that, in the example described above, the case where the liquid jet head 50 is an ink jet recording head is described. However, the liquid jet head in accordance with the invention is also applicable as, for example, a color material jet head used for manufacturing color filters for liquid crystal displays and the like, an electrode material jet head used for forming electrodes for organic EL displays, FED (Field Emission Displays) and the like, and a bioorganic material jet head used for manufacturing bio-chips.

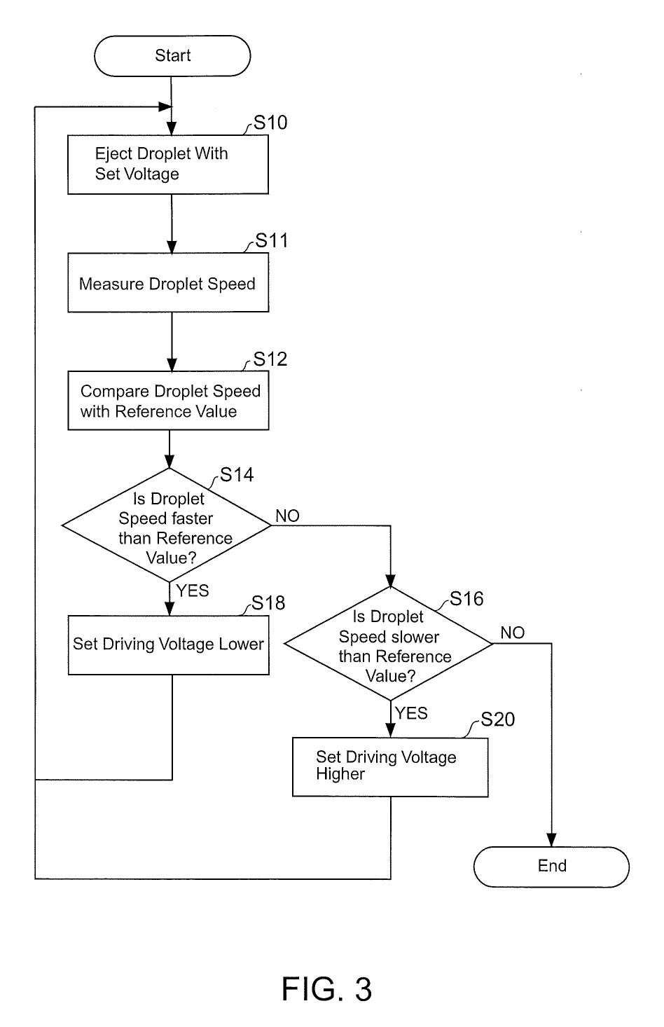

1.2. Next, a method for controlling the liquid jet head 50 in accordance with an embodiment of the invention is described. FIG. 3 is a flowchart of the method for controlling the liquid jet head 50 in accordance with the embodiment.

First, a predetermined voltage is applied across the upper and lower electrodes of the liquid jet head 50, thereby ejecting droplets (step S10: first step: droplet jetting step). As the voltage that can be initially set, for example, a pulse voltage at 50 Hz that varies between a lowest voltage (for example, −3 V) and a driving voltage (for example, 35 V) with a reference at +15 V may be used. The magnitude of the voltage to be set may be expressed by, for example, a difference between the lowest voltage and the driving voltage.

Next, the speed of the droplets ejected is measured, using a laser beam (step S11: second step: measurement step. For example, this step can be conducted as follows.

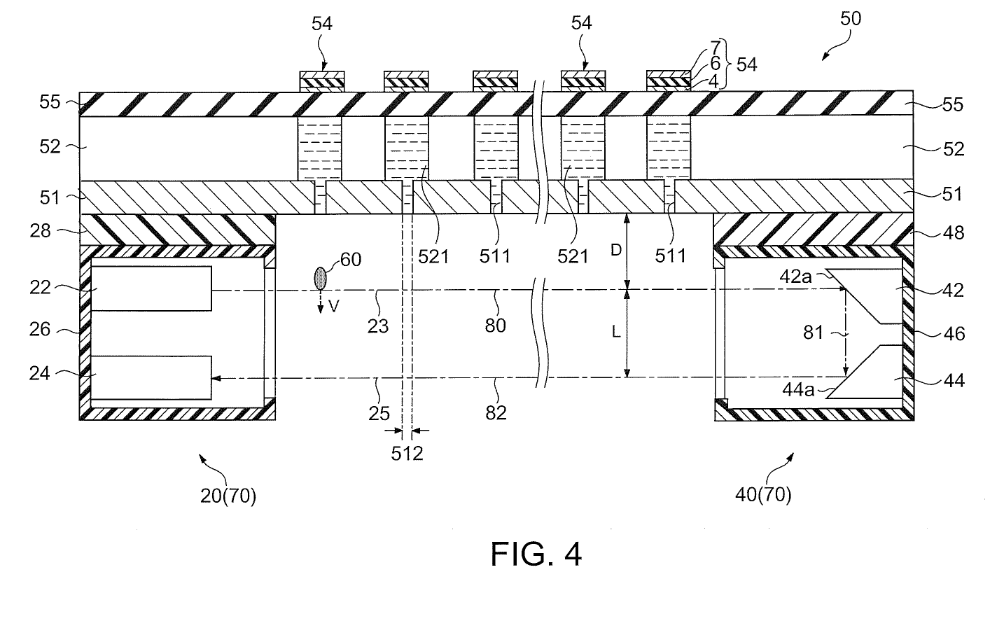

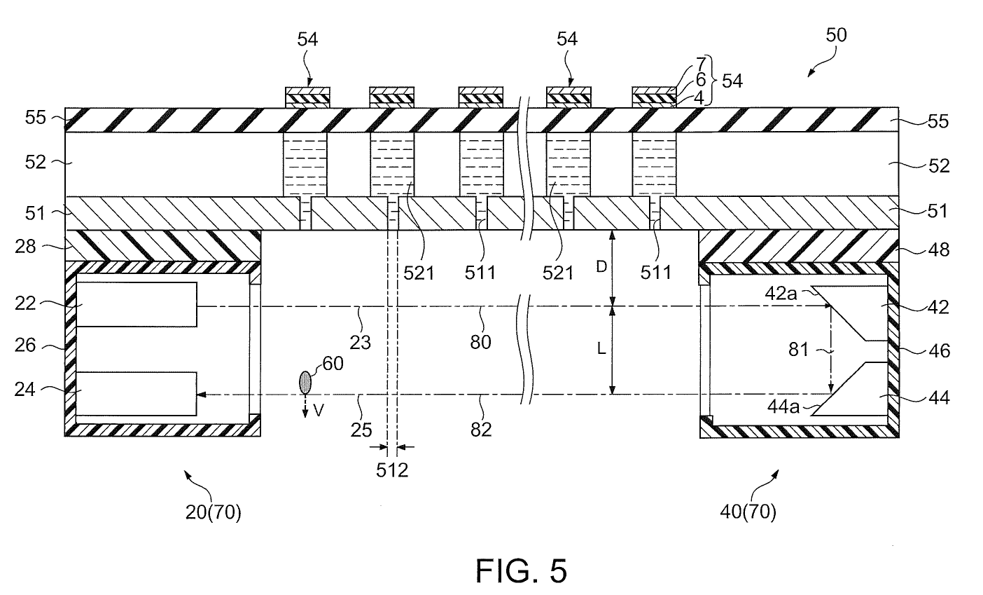

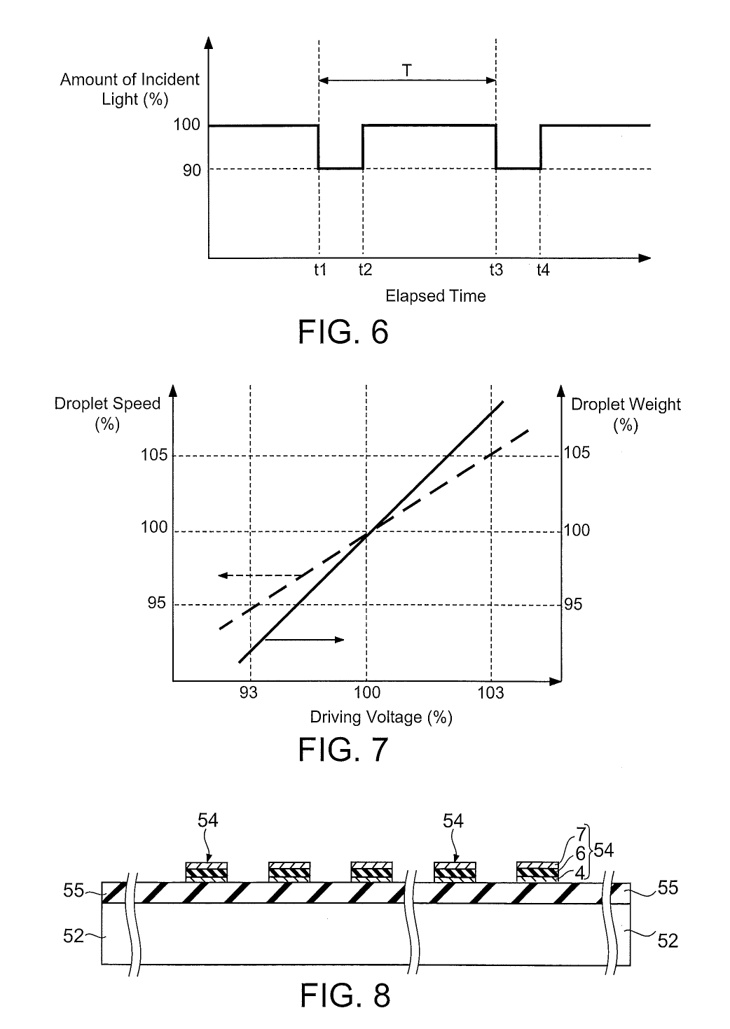

FIG. 4 and FIG. 5 are schematic cross-sectional views showing steps of the method for controlling the liquid jet head 50 in accordance with the present embodiment, and correspond to the cross-sectional view shown in FIG. 1. It is noted that FIG. 4 shows a state in which time t₁ has elapsed since a droplet 60 was ejected, and FIG. 5 shows a state in which time t₃ has elapsed since the droplet 60 was ejected. Also, FIG. 6 shows the relation between the elapsed time and the amount of light of the laser beam 82 that is incident upon the light detecting element 24.

After time t₁ elapses, the droplet 60 can drop while blocking the laser beam 80 emitted from the laser element 22 until time t₂ elapses, as shown in FIGS. 4-6. When the amount of light of the laser beam 80 before being blocked by the droplet 60 is assumed to be 100%, during this period, the amount of light of the laser beam 82 incident upon the light detecting element 24 lowers, for example, to 90%. The amount of light reduced is not limited to the exemplary amount (10%) shown, and may amount to 100%, for example.

After time t₂ elapsed and until time t₃ elapses, the droplet 60 does not block the laser beam, such that, during this period, the amount of light of the laser beam 82 incident upon the light detecting element 24 recovers to 100%. After time t₃ elapsed, and until time t₄ elapses, the droplet 60 can drop while blocking the laser beam 82 that is incident upon the light detecting element 24. During this period, the amount of light of the laser beam 82 incident upon the light detecting element 24 reduces to, for example, 90%. After time t₄ elapsed, the droplet 60 does not block the laser beam, such that the amount of light of the laser beam 82 incident upon the light detecting element 24 recovers to 100%.

Therefore, by monitoring the reduction in the amount of incident light at the light detecting element 24, specific values of elapsed time t₁-t₄ can be measured. When the distance between the laser beam 80 emitted from the laser element 22 and the laser beam 82 to be incident upon the light detecting element 24, in other words, the distance between the optical axis 23 of the laser element 22 and the optical axis 25 of the light detecting element 24, is L, the speed V of the droplet 60 can be expressed by, for example, the following formula:

V=L/(t₃−t₁)=L/T Formula (1), or

V=L/(t₄−t₂)=L/T Formula (2)

The distance L may be set to a predetermined value (for example, 1 cm), and therefore the actual speed V of the droplet 60 can be obtained from Formula (1) or Formula (2).

As described above, the droplet 60 passes the laser beams twice, and the speed V of the droplet 60 can be obtained from the distance L between the two laser beams 80 and 82, and the time T in which the droplet 60 drops (passes) the distance L. In other words, the measurement section 70 can measure the speed V of the droplet 60 ejected from the nozzle aperture 511 by using the laser beams 80 and 82.

Next, the speed of the droplet 60 measured is compared with a reference value (step S12, S14, S16: third step: comparison step). The reference value is a reference speed of a droplet, and may be, for example, 9.0 m/sec. As the reference value, any desired value can be used. Next, the voltage is reset according to the result of comparison (fourth step: resetting step). For example, when the result of comparison indicates that the speed of the droplet 60 is greater than the reference value, the voltage value is reset (step S18) such that the magnitude of the preliminarily set voltage becomes smaller (for example, to set the driving voltage lower). For example, by lowering the driving voltage, the speed of the droplet can be lowered closer to the reference value, as shown in FIG. 7. It is noted that FIG. 7 is a graph showing the relation between the driving voltage and the droplet speed, and the relation between the driving voltage and the droplet weight. FIG. 7 shows values with a droplet speed (for example, 9.0 m/sec) and a droplet weight (for example, 8 ng) when a driving voltage is at a predetermined value (for example 35V), respectively, as a reference (100%).

Furthermore, for example, when the result of comparison indicates that the speed of the droplet 60 is lower than the reference value, the voltage value is reset (step S20) such that the magnitude of the preliminarily set voltage becomes greater (for example, to set the driving voltage higher). For example, by making the driving voltage higher, the speed of the droplet can be elevated closer to the reference value, as shown in FIG. 7.

After the voltage has been reset (step S18 or step S20), the operation can be returned to the first step (step S10) where the reset voltage is applied to the liquid jet head 50 to eject a droplet. In this manner, a series of the steps from the first step to the fourth step may be repeated a plurality of times. It is noted that the operation may be completed when a series of the steps from the first step to the fourth step is conducted only once. In this case, in the fourth step (resetting step), the voltage may be reset to a voltage that is equal to the voltage set in the first step (droplet jetting step) or to a different voltage.

When the measured speed V of the droplet 60 and the reference value are compared (step S12), and the result of the comparison indicates that the values are the same, the process is ended, and the droplet 60 can be jetted at a desired speed (=the reference value). Even when the measured speed V of the droplet 60 and the reference value are not equal to each other, the speed of the droplet 60 can be changed closer to the desired speed according to the execution flow described above. Accordingly, it is also possible to end the process at the time when the speed of the droplet 60 reaches the desired speed.

By controlling the voltage applied to the liquid jet head 50 as described above, a desired droplet speed can be obtained. The droplet speed and the droplet weight have a correlation, as indicated in FIG. 7, and therefore a desired droplet weight can be obtained by obtaining a desired corresponding droplet speed. Accordingly, by using the liquid jet head 50 in the state where the execution flow described above is completed, the droplet 60 having a desired weight can be ejected. In other words, correction of the droplet weight can be performed.

It is noted that the droplet weight correction may be conducted for each of droplets 60 ejected from all of the nozzle apertures 511, or for droplets 60 ejected from a part of the nozzle apertures 511, respectively.

Also, there are cases where the droplet weight is considerably reduced in an initial stage of operation of the liquid jet head 50, the frequency of conducting correction of the droplet weight may be increased in the initial stage of operation of the liquid jet head 50, and then later reduced.

Furthermore, the aforementioned reference value may include two values in different magnitudes. In this case, when the droplet speed is faster than the greater one of the reference values, for example, the driving voltage may be made lower; and when the droplet speed is slower than the smaller one of the reference values, for example, the driving voltage may be made higher. By this, the droplet weight can be brought in a desired range.

1.3. Next, a method for manufacturing a liquid jet head 50 in accordance with an embodiment of the invention is described. FIG. 8 is a schematic cross-sectional view showing a step of the method for manufacturing a liquid jet head 50 in accordance with the embodiment of the invention, and corresponds to the cross-sectional view shown in FIG. 1.

(1) First, as shown in FIG. 8, an elastic plate 55 is formed on a substrate 52. The elastic plate 55 may be formed by, for example, a thermal oxidation method or a CVD (chemical vapor deposition) method.

(2) Next, as shown in FIG. 8, driving sections 54 are formed on the elastic plate 55. More specifically, a lower electrode layer 4, a piezoelectric layer 6 and an upper electrode layer 7 are formed in this order on the entire top surface of the elastic plate 55. The lower electrode layer 4 is formed by, for example, a sputtering method. The piezoelectric layer 6 is formed by, for example, a sol-gel method (a solution method). The upper electrode layer 7 is formed by, for example, a sputtering method. Then, for example, the upper electrode layer 7, the piezoelectric layer 6 and the lower electrode layer 4 are patterned, thereby forming a columnar section in a desired configuration. Each of the layers may be patterned by, for example, lithography technique and etching technique. It is noted that the lower electrode layer 4, the piezoelectric layer 6 and the upper electrode layer 7 may be patterned individually upon formation of each of the layers, or patterned in groups upon formation of a plurality of the layers. According to the steps described above, the driving section 54 having the lower electrode 4, the piezoelectric layer 6 and the upper electrode 7 is formed.

(3) Next, as shown in FIG. 1 and FIG. 2, the substrate 52 is patterned, thereby forming opening sections 521. The substrate 52 may be patterned by, for example, lithography technique and etching technique.

(4) Next, as shown in FIG. 1 and FIG. 2, a nozzle plate 51 is adhered to the lower surface (the upper surface in FIG. 2) of the substrate 52 at predetermined positions with adhesive or the like.

(5) Then, as shown in FIG. 1 and FIG. 2, a measurement section 70 is affixed to the lower surface (the upper surface in FIG. 1) of the nozzle plate 51 at a predetermined position. More specifically, an optical element housing 26 having a laser element 22 and a light detecting element 24 affixed on the inside thereof is prepared, and the optical element housing 26 is affixed to the lower surface of the nozzle plate 51 at a predetermined position through, for example, a first spacer 28, using adhesive or the like. Also, a mirror housing 46 having a first mirror 52 and a second mirror 44 affixed on the inside thereof is prepared, and the mirror housing 46 is affixed to the lower surface of the nozzle plate 51 at a predetermined position through, for example, a second spacer 48, using adhesive or the like.

Through the steps described above, the liquid jet head 50 in accordance with the present embodiment is formed, as shown in FIG. 1 and FIG. 2.

1.4. According to the method for controlling a liquid jet head 50 in accordance with the present embodiment, a droplet 60 having a desired droplet weight can be ejected, as described above. By this, for example, even when the liquid jet head 50 is used for an extended period of time, changes in the droplet weight can be suppressed, and the reliability of the liquid jet head 50 can be improved.

Also, according to the method for controlling a liquid jet head 50 in accordance with the present embodiment, the liquid weight of each of droplets 60 ejected from a plurality of nozzle apertures 511 can be set at a desired value. Accordingly, variations in the weight of the droplets ejected from the nozzle apertures 511 can be reduced.

Also, according to the method for controlling a liquid jet head 50 in accordance with the present embodiment, for example, it is possible to detect if a droplet 60 is not ejected due to clogging or other reasons.

Also, the liquid jet head 50 in accordance with the present embodiment can achieve the method for controlling a liquid jet head described above.

1.5. Next, liquid jet head in accordance with modified examples of the embodiment are described. It is noted that aspects different from those of the above-described liquid jet head 50 and its control method (hereafter referred to as the “example of liquid jet head 50”) in accordance with the embodiment are described, and descriptions of similar aspects are omitted.

(1) First, a first modified example is described.

In the example of liquid jet head 50 described above, the laser element 22 in the laser element section 20 is provided above the light detecting element 24. However, for example, the positions of the laser element 22 and the light detecting element 24 may be inverted, whereby the laser element 22 may be provided below the light detecting element 24.

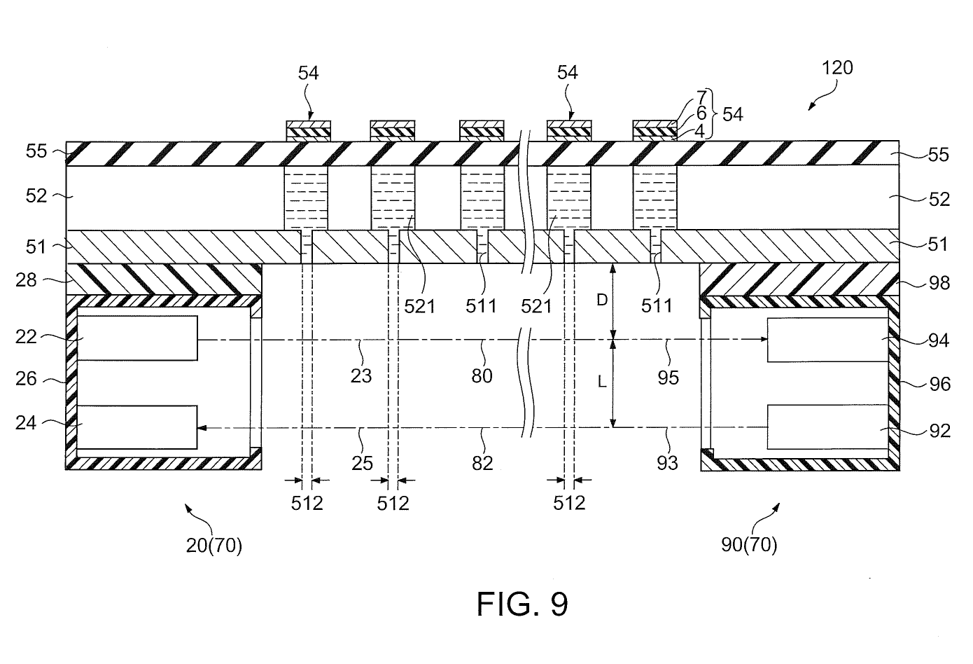

(2) Next, a second modified example is described. FIG. 9 is a schematic cross-sectional view of a liquid jet head 120 in accordance with the modified example.

In the example of liquid jet head 50 described above, the measurement section 70 has one optical element section 20, and one reflection section 40. However, for example, the measurement section 70 may have two optical element sections 20 and 90, and may not be provided with a reflection section. The first optical element section 20 includes a first laser element 22 and a first light detecting element 24 provided below the first laser element 22. The second optical element section 90 includes a second laser element 92 and a second light detecting element 94 provided above the second laser element 92. A laser beam 80 emitted from the first laser element 22 is incident upon the second light detecting element 94. A laser beam 82 emitted from the second laser element 92 is incident upon the first light detecting element 24. An optical axis 23 of the first laser element 22 is aligned with an optical axis 95 of the second light detecting element 94, and an optical axis 93 of the second laser element 92 aligns with an optical axis 25 of the first light detecting element 24.

As the amount of incident light which is described above in conjunction with the example of liquid jet head 50 (see FIG. 6), the amount of light incident upon the first light detecting element 24 and the amount of light incident upon the second light detecting element 94 may be combined in the present modified example. Alternatively, by using the amount of light incident upon the first light detecting element 24 alone, time t₁ or t₂ indicated in FIG. 6 may be obtained; or by using the amount of light incident upon the second light detecting element 92 alone, time t₃ or t₄ indicated in FIG. 6 may be obtained.

(3) Next, a third modified example is described.

According to the second modified example described above, the first optical element section 20 has one laser element 22 and one light detecting element 24, and the second optical element section 90 has one laser element 92 and one light detecting element 94. However, for example, the first optical element section may have two laser elements, and the second optical element section may have two light detecting elements. Laser beams emitted from the two laser elements at the first optical element section may be incident upon the two light detecting elements at the second optical element section. The amounts of light incident upon the two light detecting elements may be added together, or the amount of light incident upon each of the light detecting elements may be individually used to obtain times t₁-t₄ shown in FIG. 6 in a manner similar to those described above in the second modified example.

(4) The modified examples described above are only examples, and the invention is not limited to these modified examples. For example, it is possible to combine the first modified example and the second modified example. Also, according to the necessity, these modified examples are also applicable to a second embodiment to be described below.

2. Second Embodiment

2.1. Next, a printer 600 in accordance with a second embodiment of the invention is described. Here, the case where the printer 600 in accordance with the embodiment is an ink jet printer is described.

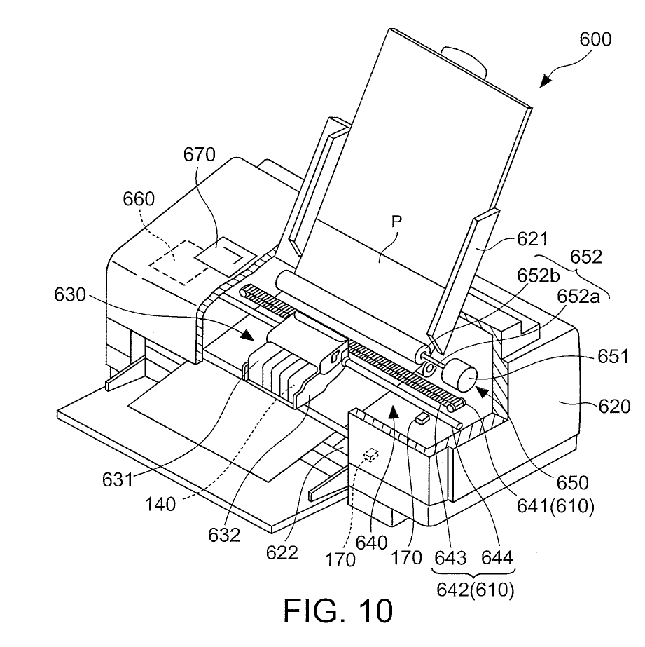

FIG. 10 is a schematic perspective view of a printer 600 in accordance with the embodiment of the invention. The printer 600 includes a head unit 630, a measurement section 170, a head unit driving section 610, and a controller section 660. Also, the printer 600 may include an apparatus main body 620, a paper feed section 650, a tray 621 for holding recording paper P, a discharge port 622 for discharging the recording paper P, and an operation panel 670 disposed on an upper surface of the apparatus main body 620.

The head unit 630 includes a liquid jet head that is an ink jet recording head (hereafter simply referred to as the “head”) 140. The head unit 630 is further quipped with ink cartridges 631 that supply inks to the head 140, and a transfer section (carriage) 632 on which the head 140 and the ink cartridges 631 are mounted.

The head 140 includes a nozzle plate, a substrate, an elastic plate and a driving section. As these members, for example, the same members as those used for the liquid jet head in accordance with the first embodiment described above may be used.

The measurement section 170 may be provided independently from the liquid jet head 140. As the measurement section 170, the one that is the same as the measurement section 70 used for the liquid jet head 50 in accordance with the first embodiment described above may be used. The measurement section 170 may be affixed, for example, on the inside of the apparatus main body 620. The measurement section 170 may be connected to wirings (not shown).

The head unit driving section 610 is capable of reciprocally moving the head unit 630. The head unit driving section 610 includes a carriage motor 641 that is a driving source for the head unit 630, and a reciprocating mechanism 642 that receives rotations of the carriage motor 641 to reciprocate the head unit 630.

The reciprocating mechanism 642 includes a carriage guide shaft 644 with its both ends being supported by a frame (not shown), and a timing belt 643 that extends in parallel with the carriage guide shaft 644. The carriage 632 is supported by the carriage guide shaft 644, in a manner that the carriage 632 can be freely reciprocally moved. Further, the carriage 632 is affixed to a portion of the timing belt 643. By operations of the carriage motor 641, the timing belt 643 is moved, and the head unit 630 is reciprocally moved, guided by the carriage guide shaft 644. During these reciprocal movements, the ink is jetted from the head 140 and printed on the recording paper P.

The control section 660 can control the head unit 630, the measurement section 170, the head unit driving section 610 and the paper feeding section 650.

The paper feeding section 650 can feed the recording paper P from the tray 621 toward the head unit 630. The paper feeding section 650 includes a paper feeding motor 651 as its driving source and a paper feeding roller 652 that is rotated by operations of the paper feeding motor 651. The paper feeding roller 652 is equipped with a follower roller 652a and a driving roller 652b that are disposed up and down and opposite to each other with a feeding path of the recording paper P being interposed between them. The driving roller 652b is coupled to the paper feeding motor 651.

The head unit 630, the head unit driving section 610, the control section 660 and the paper feeding section 650 are provided inside the apparatus main body 620.

It is noted that the example is described above as to the case where the printer 600 is an ink jet printer. However, the printer in accordance with the invention is also applicable to an industrial liquid jet apparatus. As the liquid (liquid material) to be jetted in this case, a variety of liquids each containing a functional material whose viscosity is adjusted by a solvent or a disperse medium may be used.

2.2. According to the printer 600 in accordance with the present embodiment, the measurement section 170 is provided independently from the liquid jet head 140, such that the liquid jet head 140 can be made smaller in size, compared to the liquid jet head 50 in accordance with the first embodiment described above. Furthermore, as the measurement section 170 is provided independently from the liquid jet head 140, the measurement section 170 can be provided at any desired location even when, for example, the distance between the recording paper P and the liquid jet head 140 is extremely short, whereby the distance D between the nozzle plate and the laser beam (see FIG. 1), and the distance L between the laser beams (see FIG. 1) can be set to desired values.

Also, according to the printer 600 in accordance with the present embodiment, the reliability of the liquid jet head 140 can be improved by the use of the measurement section 170. The same reasons as described above in conjunction with the liquid jet head in accordance with the first embodiment may be applied in this case.

Moreover, according to the printer 600 in accordance with the present embodiment, the method for controlling a liquid jet head in accordance with the first embodiment described above can be realized.

2.3. Next, a printer in accordance with a modified example of the embodiment is described. It is noted that only aspects different from those of the printer 600 in accordance with the embodiment described above (hereafter referred to as the “example of printer 600”) are described, and descriptions of similar aspects are omitted.

(1) In the example of printer 600 described above, the measurement section 170 is provided independently from the liquid jet head 140. However, the printer in accordance with the modified example may be equipped with the liquid jet head in accordance with the first embodiment in which the measurement section 170 of the example of printer 600 and the liquid jet head 140 are formed in one piece.

(2) It is noted that the modified example is merely an example, and the invention is not limited to the modified example.

3. Embodiments of the invention are described above in detail. However, those having ordinary skill in the art should readily understand that many modifications can be made without departing in substance from the new matters and effects of the invention. Accordingly, all of those modified examples should also be included in the scope of the invention.

What is claimed is:

1. A method for controlling a liquid jet head, comprising:
a first step of applying a specified voltage to the liquid jet head to eject a droplet;
a second step of measuring the speed of the droplet by using a laser beam;
a third step of comparing the speed of the droplet measured and a reference value; and
a fourth step of re-setting the voltage according to a comparison result.

2. A method for controlling a liquid jet head according to claim 1, wherein a series of the first step through the fourth step is repeated a plurality of times.

3. A method for controlling a liquid jet head according to claim 1, wherein, in the second step, the droplet passes through the laser beam in two points, and the speed of the droplet is obtained from a distance between the two points and a time for which the droplet travels the distance.

4. A liquid jet head comprising:
a nozzle plate having a nozzle aperture connecting to a pressure chamber;
a substrate formed above the nozzle plate and having an opening section composing the pressure chamber;
an elastic plate formed above the pressure chamber;
a driving section formed above the elastic plate; and
a measurement section that is formed below the nozzle plate and measures the speed of a droplet ejected from the nozzle aperture with a laser beam.

5. A liquid jet head according to claim 4, wherein the measurement section includes a laser element that emits the laser beam, a reflection section that reflects the laser emitted from the laser element and outputs the laser beam in an opposite direction, and a light detecting element that detects the laser beam, wherein an optical axis of the laser element and an optical axis of the light detecting element are in parallel with each other, and traverse a region vertically below the nozzle aperture; the laser element and the reflection section are disposed at a position where the laser beam emitted from the laser element is incident upon the reflection section with the optical axis of the laser element being an optical path; and the reflection section and the light detecting element are disposed at a position where the laser beam reflected from the reflection section is incident upon the light detecting element with the optical axis of the light detecting element being as an optical path.

6. A liquid jet head according to claim 4, wherein the measurement section includes two laser elements that emit the laser beams, and two light detecting elements that receive the laser beams, wherein optical axes of the two laser elements may be in parallel with each other and traverse a region vertically below the nozzle aperture; the optical axis of one of the laser elements aligns with an optical axis of one of the light detecting elements; and the optical axis of the other of the laser elements aligns with an optical axis of the other of the light detecting elements.

7. A liquid jet head according to claim 4, wherein the driving section includes a lower electrode, a piezoelectric layer formed above the lower electrode, and an upper electrode formed above the piezoelectric layer.

8. A printer comprising the liquid jet head recited in claim 4.

9. A printer comprising:
a head unit having a liquid jet head;
a measurement section that measures the speed of a droplet ejected from the liquid jet head with a laser beam;
a head unit driving section that reciprocates the head unit; and
a control section that controls the head unit, the measurement section and the head unit driving section.
